(19) United States
(12) Patent Application Publication
(10) Pub. No.: US 2011/0024637 A1
(43) Pub. Date: Feb. 3, 2011

(54) OPEN-TYPE PET SCANNER

(75) Inventors: Taiga Yamaya, Chiba-shi (JP); Hideo Murayama, Chiba-shi (JP); Naoko Inadama, Chiba-shi (JP)

Correspondence Address: OLIFF & BERRIDGE, PLC, P.O. BOX 320850, ALEXANDRIA, VA, 22320-4850, US

(73) Assignee: NATIONAL INSTITUTE OF RADIOLOGICAL SCIENCES, Chiba-shi, Chiba (JP)

(21) Appl. No.: 12/935,016

(22) PCT Filed: Apr. 1, 2008
(86) PCT No.: PCT/JP2008/056451

§ 371 Date: Sep. 28, 2010

(51) Int. Cl. G01T 1/161

(52) U.S. Cl. 250/363.02

(57) ABSTRACT

In an open-type PET scanner, detector rings arranged in a multilayered manner in an axial direction are at least partially opened and the thus opened part of the detector rings is at least partially included in a main focus region. Then, at least some of the detecting elements constituting the detector ring are disposed obliquely in the axial direction so that the main sensitivity direction thereof is turned closer to the main focus region, increasing the resolution in the main focus region. Thereby, it is possible to retain resolution in the body axis direction without using a high-resolution DOI detector and to reduce the price of the open-type PET scanner.

### TECHNICAL FIELD

The present invention relates to an open-type PET scanner in which detector rings arranged in a multilayered manner in an axial direction are at least partially opened and the thus opened part of the detector rings is at least partially included in a main focus region. In particular, the present invention relates to an open-type PET scanner capable of constituting the detector rings with inexpensive detectors.

### BACKGROUND ART

Positron emission tomography (PET) which has gained attention as being effective in making an early diagnosis of cancers, cerebrovascular disorders, dementia and others. PET is a method for injecting a compound labeled with a trace amount of a positron emission nuclide to detect annihilation radiation emitted from the body, thereby imaging of metabolic functions such as sugar metabolism and examining the presence or absence of a disease and the seriousness of a disease. For the implementation thereof, PET scanners have been put into practical use.

In order to increase the sensitivity of a PET scanner, as illustrated in FIG. 1(a), it is necessary to increase a solid angle by arranging a detector 10 in a tunnel shape. However, a long tunnel-shaped patient port not only causes increased psychological stress to a patient 6 under examination but also affects medical care of the patient 6. In order to cope with this problem, as illustrated in FIG. 1(b), the applicant has proposed an open-type PET scanner in which detector rings 11, 12 which have been divided into plural regions in the body axis direction are arranged apart to have a field-of-view (also referred to as an open field-of-view) which is physically opened. In an open region, as shown in FIG. 2, an image is reconstructed from remaining coincidence lines between the detector rings 11, 12. In giving medical treatment such as radiation therapy while an open space is used to conduct a PET diagnosis, the highest resolution performance is required at this open space. In this drawing, the reference number 8 depicts a bed.

On the other hand, for the detector 10 constituting the detector rings, a scintillation crystal is used as a radiation detecting element, or a semiconductor device is used as a radiation detecting element. In these detectors, due to an influence of parallax resulting from the thickness of a detecting element, there is a tendency that the resolution for radiation made incident obliquely is deteriorated and the resolution in an open region in the body axis direction is deteriorated.

By referring to an example made up of two detector rings, the field-of-view of an open-type PET scanner is, as illustrated in FIG. 3(a), constructed with an intra-ring field-of-view 1 and an intra-ring field-of-view 2 covered with the respective detector rings and an open field-of-view 3 between the detector rings. In the case of an open-type PET scanner, all annihilation radiation generated at open regions is made incident into detecting elements obliquely. Therefore, as compared with the intra-ring field-of-view 1 and the intra-ring field-of-view 2, the resolution in the open field-of-view 3 in the body axis direction is deteriorated.

In contrast, as shown in FIG. 3(b), by using a Depth Of Interest (DOI) detector 16 for acquiring a three-dimensional radiation positional information including the depth direction of a detecting element, as described in Japanese Published Unexamined Patent Application No. 2004-279057, it is possible to retain resolution of all field-of-views including the open field-of-view 3 (refer to “A proposal of an open PET geometry” by Taiga Yamaya, Taku Inaniwa, Shinichi Minohara, Eiji Yoshida, Naoko Inadama, Fumihiko Nishikido, Kengo Shibuya, Chih Fung Lam and Hideo Murayama, Phy. Med. Biol., 53, pp. 757-773, 2008.

In addition, as being similar to the present invention, in FIG. 1 of “Spherical Positron Emission Tomograph (S-PET) I-Performance Analysis” by Z. H. Cho and K. S. Hong, Nuclear Instruments and Methods in Physics Research 225 (1984) pp. 442-438, such a description is made that an integral type detector ring which is not an open type is provided in a barrel type and individual detectors are arranged toward the center thereof in a radial manner.

In order to increase the resolution in an open field-of-view of an open-type PET scanner in the body axis direction, it is necessary to use a DOI detector. However, the DOI detector is constituted in a more complex manner than a conventional detector to result in an expensive scanner, which poses a problem.

Further, where a DOI detector is used, coincidence lines are increased in proportion to the square of the stage number of DOIs. Therefore, data size is increased, longer calculation time of image reconstruction is needed, and in order to shorten the image reconstruction time, introduction of an expensive high-performance computing machine is needed, thereby posing problems.

### DISCLOSURE OF INVENTION

The present invention has been made in order to solve the previously described conventional problems, an object of which is to retain image resolution in the body axis direction without using a high-resolution DOI detector, thereby reducing the price of an open-type PET scanner.

The present invention has been made, with attention given to the fact that, for example, where radiation therapy is performed from an open space in utilizing an open-type PET scanner, an open field-of-view (further, a main focus region which is a part of the region thereof) is in particular important as a region to be imaged at high accuracy and an intra-ring field-of-view is not necessarily needed to be imaged at high accuracy.

In other words, the present invention is an open-type PET scanner in which detector rings arranged in a multilayered manner in the axial direction are at least partially opened and the thus opened part of the detector rings is at least partially included in a main focus region. At least some of the detecting elements constituting the detector rings are disposed obliquely with respect to the axial direction so that the main sensitivity direction is turned closer to the main focus region to increase the resolution in the main focus region, thereby solving the above problem.

Here, the detecting rings arranged in a multilayered manner in the axial direction may be used to form a continuous field-of-view along the axis, thus making it possible to provide a plurality of main focus regions in the continuous field-of-view.

Further, it is possible to open one or more intermediate layers inside the detecting rings arranged in a multilayered manner.

Further, it is possible to dispose obliquely each of the detecting elements so that the main sensitivity direction is turned to the main focus region.

Further, it is possible to make equal an angle of gradient in the main sensitivity direction.

Further, it is possible to dispose main light-entering surfaces of the detecting elements in a stage-like manner.

Further, at least some of the detecting elements may be adjusted for an angle of gradient.

Still further, it is possible to dispose at least some of the detecting elements, with each main sensitivity direction made oblique, so as to be focused on the open region in a unit of blocks.

An open space of the open-type PET scanner is expected to be utilized as a space for medical treatment and a site for installing another device such as an X-ray CT scanner. In these cases, a field-of-view of the scanner as a whole is not always needed, and in most cases, an open region or only a part of the open region may be imaged. In this case, adoption of detecting elements arranged according to the present invention will make it possible to retain the resolution in the body axis direction without using a complicated DOI detector and thereby to reduce the price of the scanner.

Further, where the DOI detector is used, coincidence lines are increased in proportion to the square of the stage number of DOIs. Therefore, data size is increased, longer calculation time for image reconstruction is needed, and in order to shorten the image reconstruction time, introduction of an expensive high-performance computing machine is needed. However, the present invention eliminates a necessity for using the DOI detector, thus making it possible to simplify the above-described data collecting system and image reconstruction system and also to perform processing at higher speeds.

The present invention is also significantly applicable to an inexpensive DOI detector which is insufficient in DOI resolution.

### BRIEF DESCRIPTION OF THE DRAWINGS

FIG. 1(a) covers a perspective view and a cross sectional view showing a constitution of a conventional PET scanner used in general, while FIG. 1(b) covers a perspective view and a cross sectional view showing a constitution of an open-type PET scanner proposed by the inventor.

FIG. 2 is a cross sectional view showing a principle of image reconstruction in an open-type PET scanner.

FIG. 3(a) covers a side elevational view and a cross sectional view showing constitutions of the open-type PET scanner using a conventional detector and FIG. 3(b) covers a side elevational view and a cross sectional view showing constitutions of the open-type PET scanner using a DOI detector.

FIG. 4 covers a side elevational view and a cross sectional view showing a constitution of Embodiment 1 of the open-type PET scanner in the present invention.

FIG. 5 covers cross sectional views showing Embodiment 2 of the open-type PET scanner in the present invention.

FIG. 6 covers a perspective view and an enlarged cross sectional view showing Embodiment 3 of the open-type PET scanner in the present invention.

FIG. 7 covers a perspective view and an enlarged cross sectional view showing Embodiment 4 of the open-type PET scanner in the present invention.

FIG. 8(a) covers a perspective view showing Embodiment 5 of the open-type PET scanner in the present invention and FIG. 8(b) covers a cross sectional view showing Embodiment 5 of the open-type PET scanner in the present invention.

FIG. 9(a) covers a perspective view showing Embodiment 6 of the open-type PET scanner in the present invention and FIG. 9(b) covers a cross sectional view showing Embodiment 6 of the open-type PET scanner in the present invention.

FIG. 10(a) covers a perspective view showing Embodiment 7 of the open-type PET scanner in the present invention and FIG. 10(b) covers a cross sectional view showing Embodiment 7 of the open-type PET scanner in the present invention.

FIG. 11(a) covers a perspective view showing Embodiment 8 of the open-type PET scanner in the present invention and FIG. 11(b) covers a cross sectional view showing Embodiment 8 of the open-type PET scanner in the present invention.

FIG. 12(a) covers across sectional view showing a conventional example and FIG. 12(b) covers a cross sectional view showing Embodiment 9 of the present invention which are for comparison.

FIG. 13 is a cross sectional view showing Embodiment 10 of the present invention.

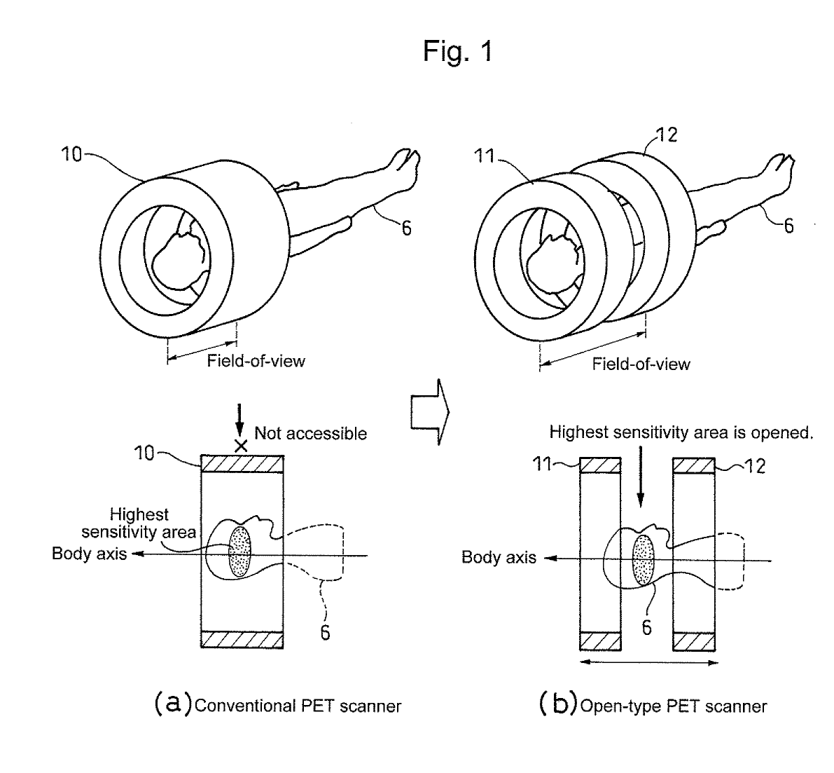

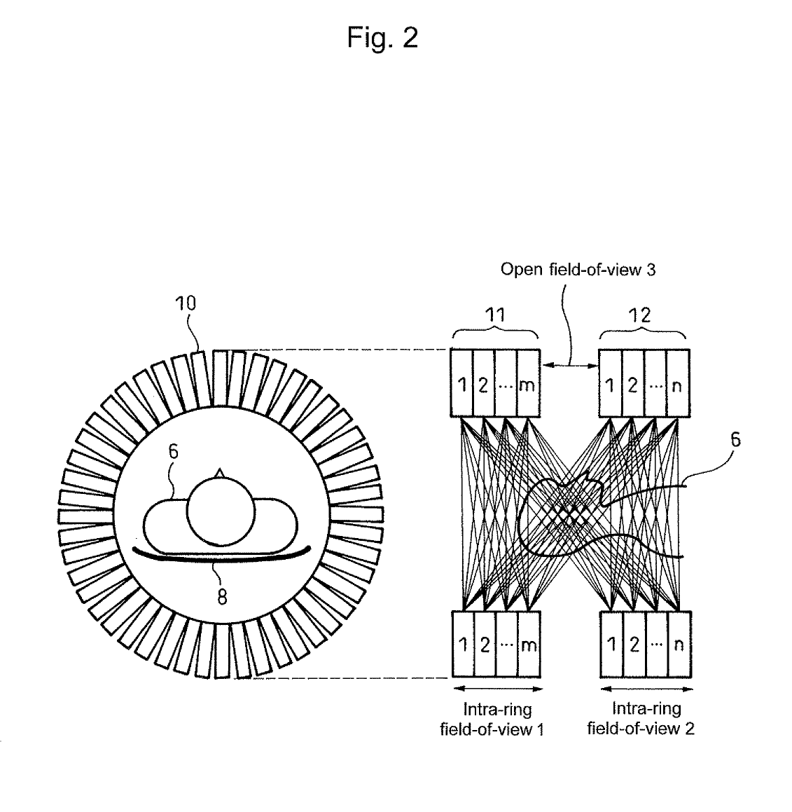

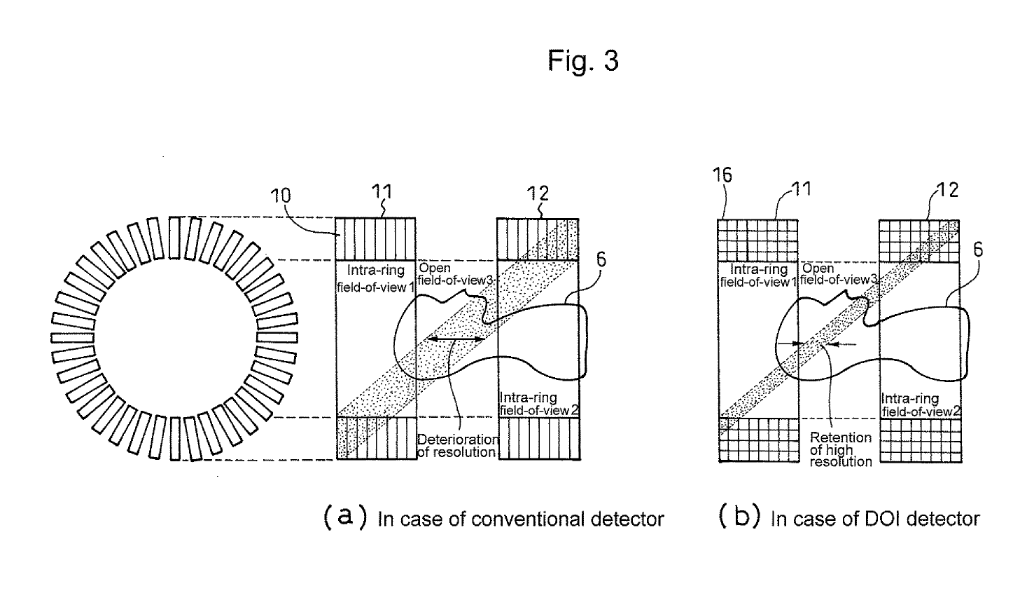

### BEST MODE FOR CARRYING OUT THE INVENTION

Hereinafter, a detailed explanation will be made for embodiments of the present invention by referring to the drawings.

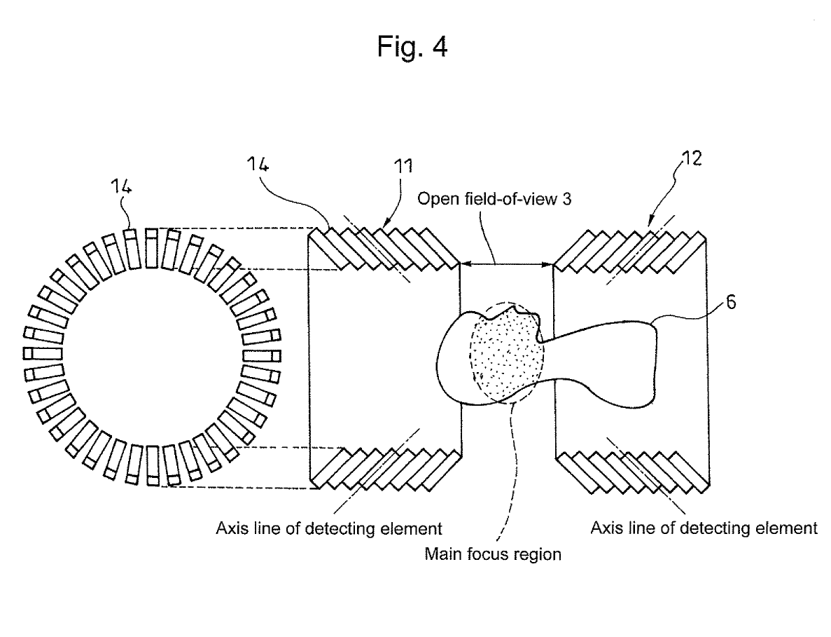

Embodiment 1 of the present invention is, as shown in FIG. 4, an open-type PET scanner in which two detector rings 11, 12 are divided in the body axis direction of a patient 6, and an open region between the two detector rings is given as an open field-of-view 3. Inside the open field-of-view 3, there is a main focus region which is to be the focuses in particular, and each detecting element 14 focuses on the open region 3 and is arranged obliquely in such a manner that annihilation radiation from the main focus region is made incident approximately parallel with the axis line of each detecting element 14 constituting the detector rings 11, 12. In addition, at each detecting element, a direction parallel with the axis line of each detecting element 14 is a main sensitivity direction with the highest sensitivity.

In this instance, crystal elements of individual detecting elements 14 constituting the detector rings 11, 12 are individually arrayed in the axial direction with no clearance left therebetween. Therefore, the individual detecting elements 14 are arranged in a stage-like manner so that these detecting elements give individually concentric circles with an equal radius. As a result, since a patient port is also formed in a right circular cylinder as with a conventional scanner, the patient 6 is able to easily enter into and exit from the PET scanner.

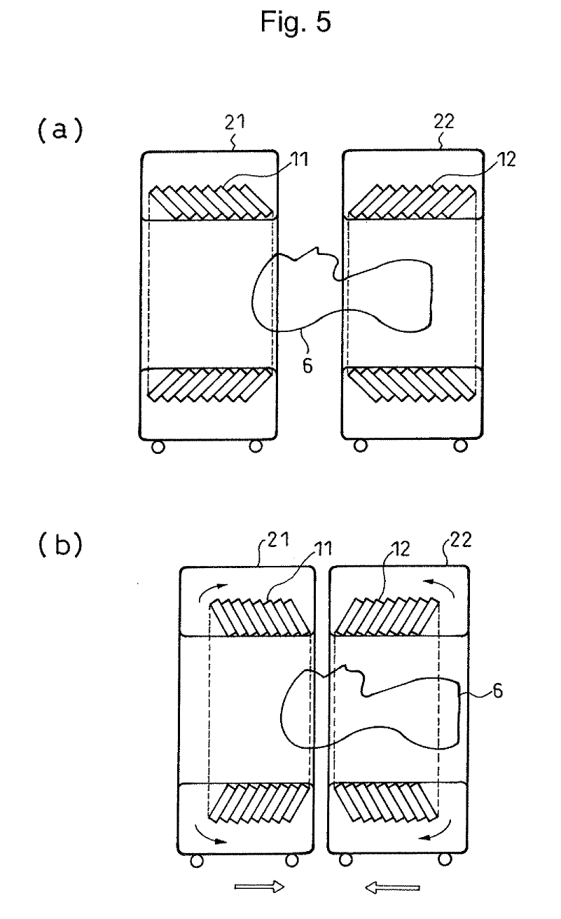

In addition, in the open-type PET scanner, as illustrated in FIG. 5(a), gantries 21, 22 for accommodating respectively the detector rings 11, 12 move back and forth, thus making it possible to change an open region. In this instance, as with Embodiment 2 shown in FIG. 5(b), a mechanism for adjusting a gradient of the detecting element 14 is provided, by which an arrangement of the detecting elements (angle of gradient) can be adjusted so as to be more precisely focused on an open region depending on movements of the gantries 21, 22 (detector rings 11, 12).

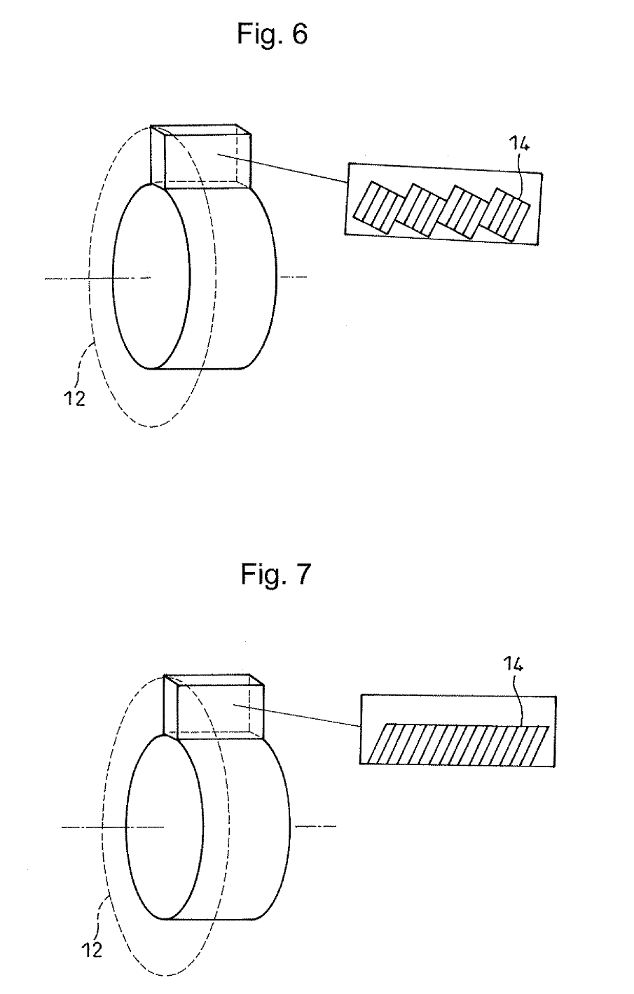

Further, where the detector has a block structure in which a certain unit of detecting elements are placed together, as with Embodiment 3 shown in FIG. 6, the detecting elements can be arranged so as to be focused by each of the blocks.

Alternatively, where the detector ring is not moved but fixed and the like, and it is not necessary to change a direction of the detecting elements, the detecting elements can be processed, as with Embodiment 4 shown in FIG. 7, for example, in the shape of a parallelogram in such a manner that each of the detecting elements has an incident surface which is inclined with respect to the axis line.

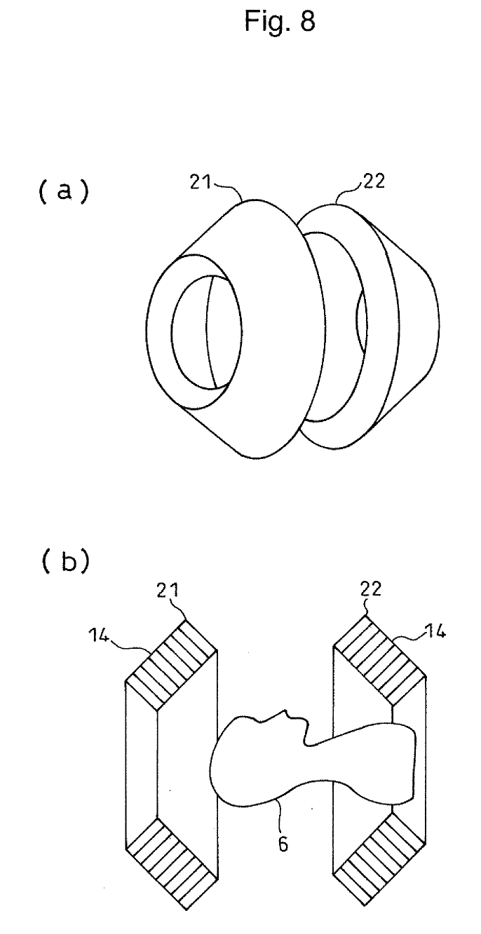

In addition, although the patient port is structured to be made narrower at an inlet and an outlet, as with Embodiment 5 shown in FIG. 8, each of the detector rings 11, 12 can be structured to give a truncated cone as a whole.

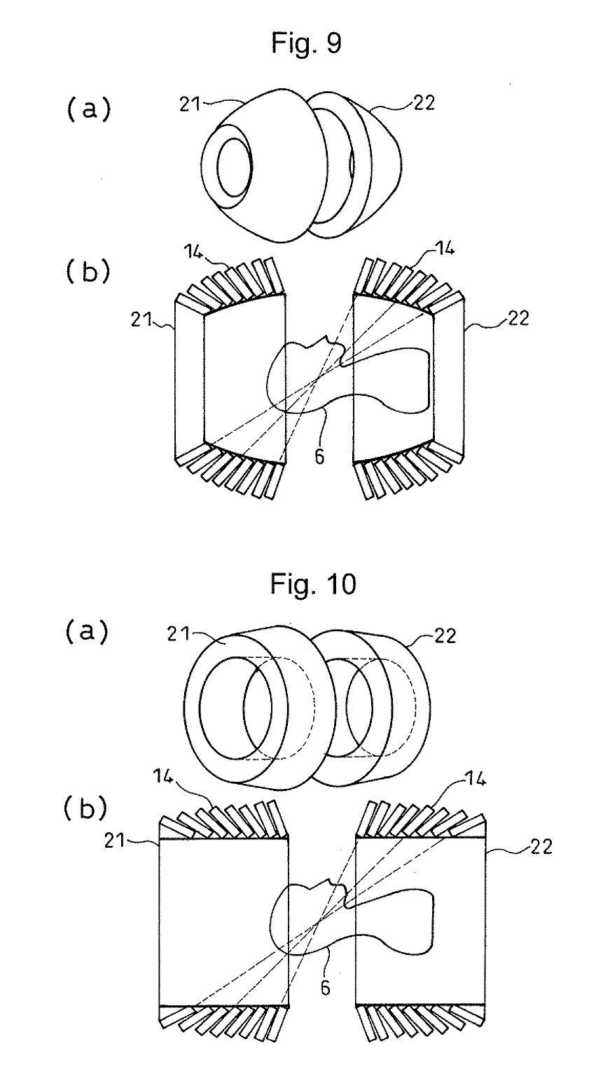

Further, where a main focus region desired to be imaged in detail is limited to a smaller region which is a part of the open region, as with Embodiment 6 shown in FIG. 9, the detecting elements 14 are arranged in a barrel shape so that the main sensitivity direction is turned to the center of the main focus region, thus making it possible to increase the sensitivity of each of the detecting elements.

In addition, in Embodiment 6, rings formed by the detecting elements 14 vary in diameter and the patient port is structured to be made narrower at an inlet and an outlet. This may pose an obstacle in placing a patient into and out of the scanner. However, in this instance, as with Embodiment 7 shown in FIG. 10, while the detecting elements 14 are focused on the center of the main focus region, they can be arranged in a cylindrical shape.

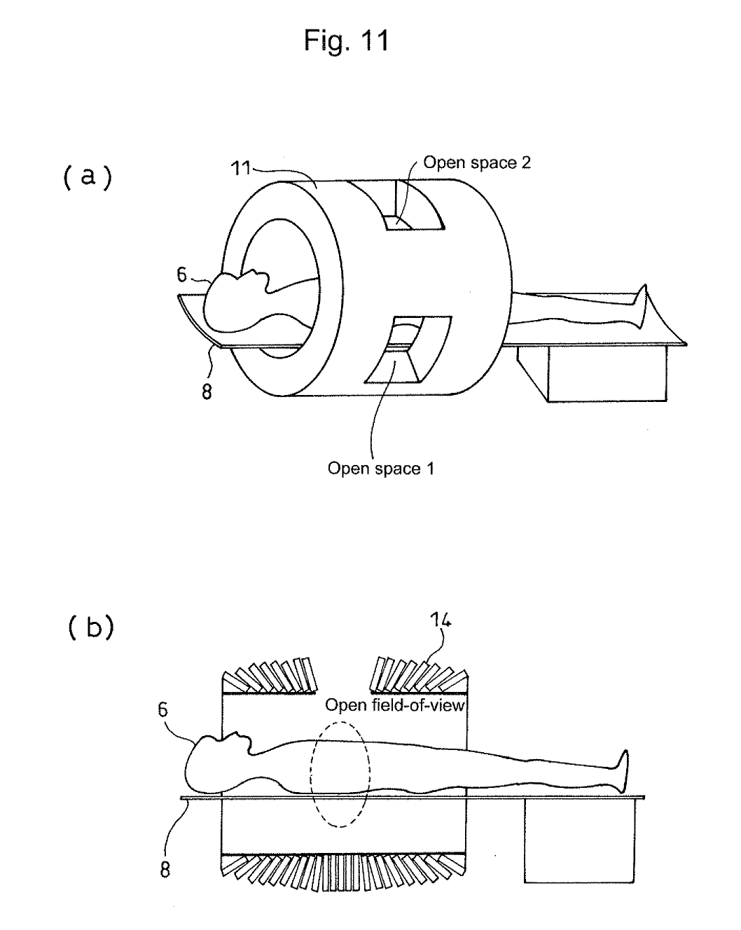

Further, as with Embodiment 8 shown in FIG. 11, the present invention is also applicable to a case where parts of the detector ring 11 are opened as open spaces 1, 2.

Here, the main focus region is not necessarily the center of an open space. A site highest in resolution based on a gradient of a detector is set outside the center of a field-of-view, by which the main focus region can be extended inside the open space or a site beyond the open space. For example, where an area around the eye and the back of the head are desired to be examined, the detector can be turned respectively slightly above the center of the field-of-view and slightly below the center thereof. The present invention is also able to deal with a case as shown in FIG. 5(b), where the vicinity of the eye is placed in the open space in order to reduce stress, but the brain as a whole is subjected to examination, and a part of the brain is hidden behind a detector ring.

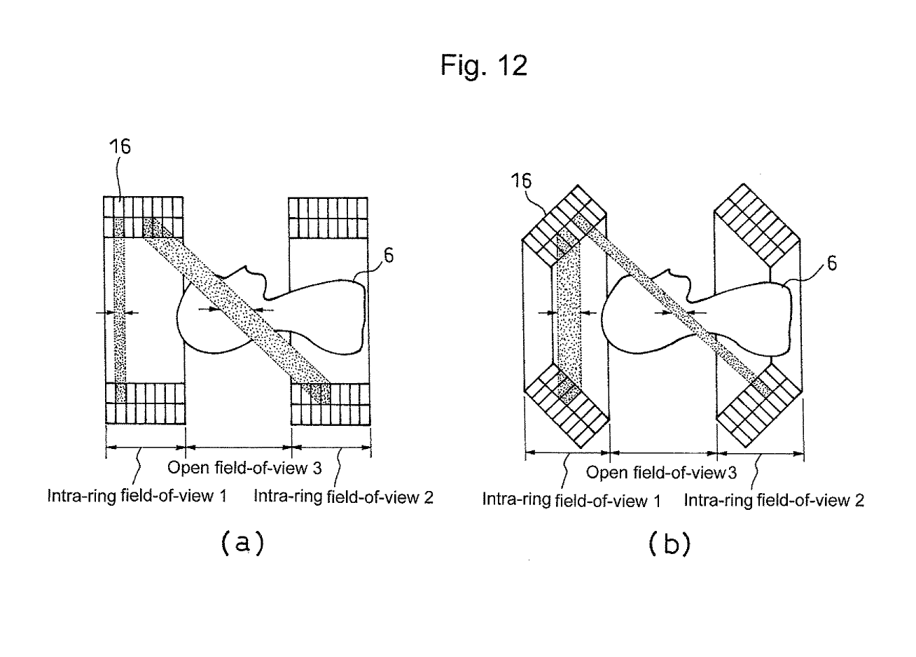

Further, a focus arrangement of the present invention is effective not only when a conventional detector is used but also when a DOI detector is used. In other words, where a DOI detector 16 is insufficient in the stage number of DOIs, as shown in FIG. 12(a), the resolution is deteriorated to a smaller extent at intra-ring field-of-views 1, 2 but the resolution is deteriorated in an open field-of-view 3. In these cases, as with Embodiment 9 shown in FIG. 12(b), the DOI detector 16 is arranged obliquely so as to be focused closer on the open field-of-view 3, by which the open field-of-view 3 can be increased in resolution. FIG. 12(b) shows an example in which the DOI detector 16 is arranged in the shape of a truncated cone. However, another method for arrangement is also similarly adoptable.

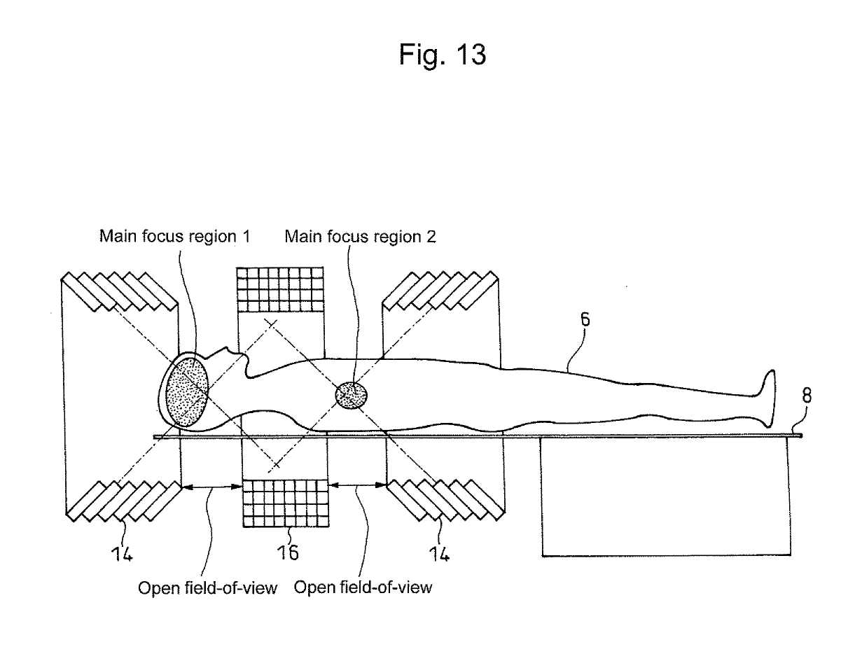

Still further, as with Embodiment 10 shown in FIG. 13, a focus arrangement according to the present invention may be combined with a DOI detector, by which the resolution can be increased in a plurality of different main focus regions 1, 2 (the drawing shows an example of two regions), for example, the brain and the heart. Here, the main focus region 1 is extended up to the inside of the detector ring 14 beyond an open space.

In addition, in any of the previously described embodiments, the detector ring has a circular cross section which is perpendicular to the body axis direction. However, the cross section of the detector ring is not limited to the above shape and may include oval and rectangular shapes.

Further, in any of the previously described embodiments, all detecting elements are disposed obliquely solely for the purpose of imaging an open field-of-view. It is also possible that some of the detecting elements are arranged to be perpendicular to the axial direction as with a conventional scanner, thus making it possible to retain the resolution in a part of an intra-ring field-of-view.

Still further, objects to be examined are not limited to humans but may include animals.

### INDUSTRIAL APPLICABILITY

The present invention is applicable to an open-type PET scanner in which detector rings arranged in a multilayered manner in the axial direction are at least partially opened and the thus opened part of the detector rings is at least partially included in a main focus region, thereby making it possible to retain image resolution in the body axis direction without using a high-resolution DOI detector and to reduce the price of the open-type PET scanner.

1. An open-type PET scanner in which detector rings arranged in a multilayered manner in an axial direction are at least partially opened and the thus opened part of the detector rings is at least partially included in a main focus region,
wherein at least some of the detecting elements constituting the detector ring are disposed obliquely in the axial direction so that the main sensitivity direction thereof is turned closer to the main focus region, thereby increasing the resolution in the main focus region.

2. The open-type PET scanner according to claim 1, wherein detector rings arranged in a multilayered manner in the axial direction are used to form a continuous field-of-view along the axis, thereby providing a plurality of main focus regions in the continuous field-of-view.

3. The open-type PET scanner according to claim 1, wherein one or more of intermediate layers inside the detector rings arranged in a multilayered manner are opened.

4. The open-type PET scanner according to claim 1, wherein
each of the detecting elements is disposed obliquely so that the main sensitivity direction thereof is turned to the main focus region.

5. The open-type PET scanner according to claim 1, wherein
the main sensitivity direction is equal in an angle of gradient.

6. The open-type PET scanner according to claim 4, wherein main light-entering surfaces of the detecting elements are disposed in a stage-like manner.

7. The open-type PET scanner according to claim 1, wherein
at least some of the detecting elements can be adjusted for an angle of gradient.

8. The open-type PET scanner according to claim 1, wherein at least some of the detecting elements are disposed, with each main sensitivity direction made oblique, so as to be focused on the main focus region in a unit of blocks.
